(19) United States
(12) Patent Application Publication
(10) Pub. No.: US 2022/0198556 A1
(43) Pub. Date: Jun. 23, 2022

(54) INVENTORY AFFORDABILITY AND POLICY DISTANCE CALCULATOR

(71) Applicant: Capital One Services, LLC, McLean, VA (US)

(72) Inventors: Saman BAGHESTANI, Plano, TX (US); Brandon DRUMHELLER, Plano, TX (US); Veerendra JOTE, Frisco, TX (US)

(73) Assignee: Capital One Services, LLC, McLean, VA (US)

(21) Appl. No.: 17/133,027

(22) Filed: Dec. 23, 2020

(51) Int. Cl. G06Q 40/02; G06Q 30/06; G06Q 30/02

(52) U.S. Cl. CPC G06Q 40/025; G06Q 30/0617; G06Q 10/087; G06Q 30/0283; G06Q 30/0625

(57) ABSTRACT

Disclosed herein are system, method, and computer program product embodiments for displaying a search result in a sales management tool that includes affordability indicators and policy distances. The search result may also display a budget distance based on customer-specific budget information. The budget and policy distances can be calculated and displayed as cash down increments and/or sales price reductions. The specified solution operates efficiently and effectively to calculate these distances and integrate them into a search result in near-real-time across all items in an inventory.

### BACKGROUND

Businesses use sales management tools to manage inventories, track sales, handle finances, market goods and services, create invoices, and perform a wide-array of other tasks. For instance, car dealerships traditionally harness sales management tools to track information about vehicles in stock, e.g., make, model, color, price, number of days in the inventory, etc. During the sales process, a sales representative may access a sales management tool to review the inventory and determine suitable items to recommend to a potential customer. The sales management tool may provide relevant information about the inventory in a search result that can be tailored by a sales representative using various search parameters. A conventional sales management tool may allow a salesperson to configure a deal in any way that makes sense for the dealership, but there are limits. For example, there are limits on what deal may be acceptable to a customer. Additionally, there may be limits on whether the deal meets the policy requirements for a lender financing the sale. Given such limitations, conventional sales management tools provided no way prior for a salesperson to understand how to configure a deal such that it is both acceptable to the customer and the lender.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of an environment including a sales management tool, according to some embodiments.

FIG. 2 is an example screen display of a search result in a sales management tool, according to some embodiments.

FIG. 3 is a flowchart illustrating a method of displaying a search result that displays affordability indicators in a sales management tool, according to some embodiments.

FIG. 4 is a flowchart illustrating a method of calculating a policy difference for display in a search result in a sales management tool, according to some embodiments.

FIG. 5 is a flowchart illustrating a method of calculating a budget difference for display in a search result in a sales management tool, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for displaying a search result in a sales management tool that includes affordability indicators and efficiently and effectively calculates distances to meeting underwriting policy constraints and customer budget. By simultaneously integrating a multitude of lender-approved loan structures, customer-specific constraints and budget parameters, dealer preferences, and inventory, the interface can provide these affordability indicators to a sales representative within the search result, solving a long-running pain point among sales management tools. This non-trivial solution thus bridges the gap between customer preferences, third-party lenders (which apply closely held proprietary underwriting algorithms), and dealerships' own preferences (which may be tracked over time).

Generally speaking, sales management tools provide businesses the ability to track inventory, complete sales transactions, create invoices, receive payment, record customer behaviors and preferences, and perform other sales-related functions. The sales management tool may store detailed information about available items in a business' inventory, i.e., in stock and/or available to be purchased by a potential customer. At a vehicle dealership, for example, the information may track the vehicles owned by the particular dealership that a potential customer may purchase. The information associated with each vehicle may include a vehicle identification number, pricing information, ownership history, vehicle characteristics such as make, model, year, and color, and other information. As a dealership acquires additional vehicles and sells vehicles, the sales management tool may update the inventory to reflect the changes. A dealership may change pricing information and perform other suitable functions.

The following paragraphs will continue to describe the interactions between a sales representative and the sales management tool with respect to a vehicle-dealership example, but one skilled in the relevant art(s) will appreciate that these interactions apply equally in other sales paradigms. For example, these interactions apply in any situation where a stored inventory of items are offered for sale by a seller, where a lender or lenders provide(s) lender-approved financing options to finance a potential purchase, and/or where, without having knowledge of a lender's proprietary underwriting algorithms, a seller is incapable of preparing an offer with certainty of meeting a lender's requirements without multiple interactions with a single or multiple lenders.

Typically, the sales process at a dealership commences when a potential customer visits a dealership in person, virtually, or otherwise. A sales manager, representative, employee, or other suitable individual may engage with the potential customer to aid them in their search. For example, the sales representative may inquire about the potential customer's brand preferences, desired vehicle colors, stylistic concerns, and various other consumer preferences. The sales representative may also acquire a general idea of the potential customer's financial situation, perhaps by asking the potential customer about their desired purchase price or budget. The sales representative may then recommend a particular vehicle to the potential customer, allow the customer to test drive the vehicle, and otherwise conduct basic sales practices to complete a sale.

After the potential customer determines that they would like to proceed with the purchase, the sales representative may then ask for detailed information about the potential customer's finances. This information may include the potential customer's credit score, desired monthly payment, desired down payment, monthly income, personal debt, etc. The sales representative only then may involve potential lenders to determine an appropriate financing solution to finalize the sale.

Throughout the sales process, the sales representative may additionally consider various characteristics and operational constraints particular to their own dealership. For example, some dealerships may focus on maximizing profits during a certain time of the year while pushing to sell vehicles that have remained on the lot for the lengthiest amount of time during another time period.

While various legacy sales management tools exist that a sales representative may leverage throughout the sales process, these tools are deficient in several respects. For one, the tools lack the ability to simultaneously consider factors spanning a multitude of lender-specific underwriting policies, inventory, dealer characteristics and customer-specific constraints and budgets. Accordingly, a legacy sales management tool may allow a sales representative to configure a desired deal, but there are downstream limits regarding both what the customer and the financing lender will accept. Thus, the sales representative operates blindly, having no way of knowing how to configure a deal to simultaneously satisfy both the customer and the lender (and the dealer itself).

Instead, in such tools, a sales representative must guess at vehicles and associated financial structures to recommend to the potential customer based on limited information about the potential customer's financial situation. When the potential customer decides that they would like to purchase a vehicle, the sales representative may only then verify that a lender offers in-policy (e.g., compliant with proprietary underwriting policies) financing structures to finance the purchase transaction of the particular vehicle for the particular customer. In such systems, the sales representative may manually select a generic financing structure and/or enter parameters statically to determine if the customer qualifies for financing. If the potential customer does not qualify, the sales representative may then select another structure or re-enter the static parameters. If no match is found, the sales representative may be forced to move on to a different, more affordable vehicle. Time is wasted.

Some legacy solutions may allow a sales representative to access a lender's system, e.g., via a web interface or programmatically using an application programming interface (API), to enter/transmit static parameters that, when considered, determine whether a potential customer qualifies to purchase a particular vehicle under the lender's terms. However, these systems remain restricted by the requirement that the financing structures, e.g., the rate and term are static and entered for each subsequent request, i.e., the structures must be hard-coded on a per-request basis when accessing the lender's site. The sales representative remains in the dark in such a solution. This requirement renders such systems incapable of dynamically determining the in-policy vs. out-of-policy status of vehicles to effectively display this information within a search results (or other standalone vehicle description) page.

Additionally, legacy systems are unable to provide inventory affordability indicators—i.e., legacy systems did not calculate, and cannot calculate, policy and budget distances across each item in the inventory. To clarify, in many instances, no deal structure may exist that satisfies the consumer constraints and the lender policy for the desired vehicle. For example, a potential customer may be attempting to purchase a vehicle that exceeds their budget and/or acceptable risk for a lender. Such a vehicle may even be very close to coverage under a policy, and perhaps just several additional dollars down payment would make the vehicle coverable in accordance with lender policy. But a sales representative using legacy systems has no access to this level of distancing information because, again, legacy systems operate statically with respect to a potential lender's acceptance of terms. Thus, the sales representative must resort to altering the static terms and guessing at an appropriate refinement to the financing terms or switching to an alternate vehicle. While eventually this might result in a policy match, the tactic may never result in a policy match, further wasting the sales representative's time. Similarly, the sales representative may overshoot the estimated refinement to the search for a financing arrangement, resulting in a sub-optimum policy for the potential customer.

A “policy distance” bridges this gap by indicating in qualitative terms how far away a particular item is from being covered by a policy. In various embodiments, this distance can be expressed as a dollar amount required to be added to a down payment, as an amount of sales-price reduction needed, or both. Other suitable approaches to express the policy distance may be adopted. For example, in other embodiments, a policy distance could be expressed as a change to term, warranty, guaranteed-asset-protection insurance modifications, other backend and front end products, trade value, participation, rebates, incentives, etc. The foregoing approaches may also be combined, i.e., operate in tandem to represent a policy distance across multiple factors/variables.

Because legacy systems do not have the ability to simultaneously integrate lender-specific underwriting policies, customer-specific constraints and budget parameters, dealer preferences, and inventory, the systems are unable to calculate the affordability indicators. In other words, legacy systems have no efficient, working method for assessing the impact of the variables in play, i.e., the potential customer's unique information, the impact of additional cash down, changes to the loan-to-value ratio, reductions in a vehicle's price, etc. so as to derive the specific policy distances in the manner described in further detail below.

Accordingly, a need exists to display a search result in a sales management tool that includes affordability indicators and calculated distances between policies and budgets.

This information may be calculated by accessing constraints and budget parameters unique to a potential customer, a multitude of lender-specific underwriting policies, and stored information about an inventory of items.

A further technical benefit is realized in an embodiment that receives budget information about the potential customer when the sales process commences. By incorporating the budget information (e.g., target monthly payment) into the structure determination/generation, the system may further hone in on an appropriate structure that is still in-policy for a particular lender. Specifically, the system may determine whether a proposed structure and items fall within the specified budget information. When the proposed structure and item do not, the system can calculate a budget distance. In various embodiments, the budget distance can be expressed as a dollar amount required to be added to a down payment, as an amount of sales-price reduction needed, or both. Other suitable approaches to express the budget distance may be adopted. For example, in other embodiments, a budget distance could be expressed as a change to term, warranty, guaranteed-asset-protection insurance modifications, other backend and front end products, trade value, participation, rebates, incentives, etc. The foregoing approaches may also be combined, i.e., operate in tandem to represent a budget distance across multiple factors. Thus, the system can further solve for budget constraints for a particular customer. This solves a further pain point for dealerships as non-financial entities are not positioned to solve for this given static rates and terms.

A further technical benefit is provided by the specific optimization techniques described below that allow the search result to calculate the affordability indicators in near-real-time. Legacy systems have no mechanism for integrating the information describing the multitude of lender-specific underwriting policies, customer-specific constraints, and expansive inventories in a manner that can allow these calculations to occur efficiently enough for systems to provide these features in near-real time.

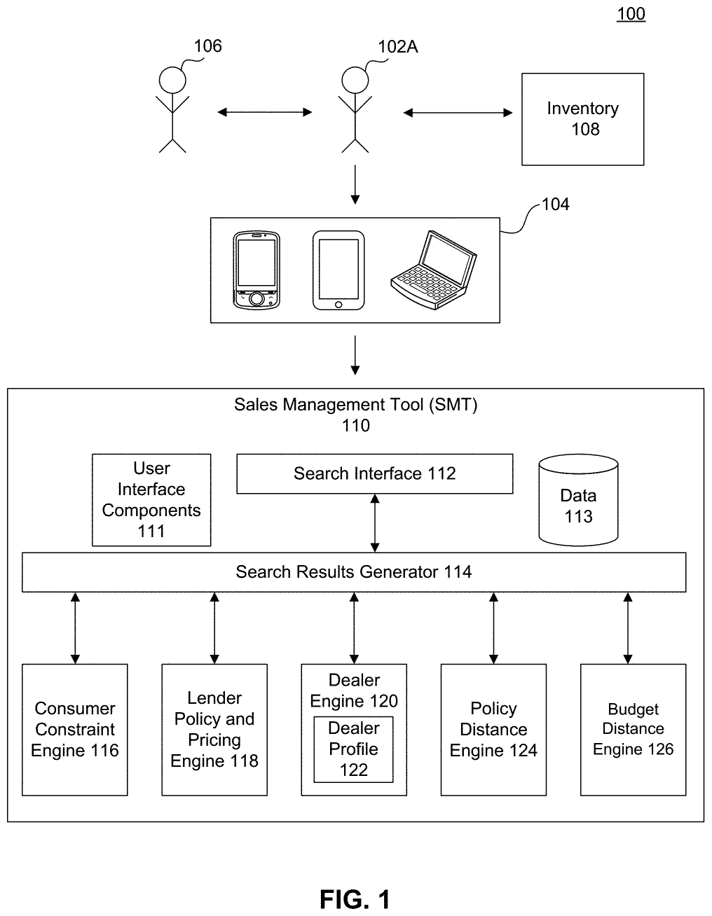

FIG. 1 is a block diagram of an environment including a sales management tool, according to some embodiments. Environment 100 may include user 102, computing device 104, potential customer 106, inventory 108, and sales management tool 110.

User 102 may be a sales agent, employee, or other representative of a business or organization. In one embodiment, user 102 may be a salesperson or employee at a vehicle dealership. In another embodiment, user 102 may be a sales representative from any appropriate business or company having an inventory of other suitable items, e.g., a clothing retailer, a wine store, a grocery store, appliance vendor, etc. User 102 may be an individual (i.e., a human being) or a group of such individuals. In yet another embodiment, user 102 may be an artificial intelligence construct. In alternative embodiments, user 102 may be a potential customer of a business interacting with sales management tool 110 to determine a desired item without the assistance of a sales representative. User 102 may access sales management tool 110 by accessing a stored user account, e.g., using a username/password combination.

Computing device 104 may be a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof. Therefore, it will also be appreciated that any two or more components of environment 100 may similarly be executed using some or all of the two or more computers in communication with one another. In an embodiment, computing device 104 may connect to sales management tool 110 via any network or combination of networks including the Internet, a local area network (LAN), a wide area network (WAN), a wireless network, a cellular network, or various other types of networks as would be appreciated by a person of ordinary skill in the art. In another embodiment, computing device 104 may have software installed thereon that facilitates the behaviors and functions of sales management tool 110.

Potential customer 106 may be an individual, group, or other construct seeking to purchase an item within an inventory. In one embodiment, potential customer 106 may be a consumer visiting, either in person, virtually, or through any other means, a dealership to investigate the purchase of an automobile, truck, motorcycle, bicycle, or other vehicle. Potential customer 106 may provide consumer constraints such as a credit score, a credit history, a monthly income, debt obligations, etc., or this information may otherwise be available to sales management tool 110. In an embodiment, potential customer 106 may be tracked in sales management tool 110 with an appropriate user account associated with potential customer 106. In an embodiment, potential customer 106 may interact with systems that are ancillary to sales management tool 110, for example, personal banking systems to import or otherwise access consumer constraints about potential customer 106. For example, sales management tool 110 may have access to details about the consumer constraints of potential customer 106 by accessing the ancillary systems via an API call, micro-service, or other suitable interface.

Inventory 108 may be an inventory of tangible or intangible items available at a business or other commercial entity. In one embodiment, the items in inventory 108 are vehicles and the business offering the vehicles for sale is a car dealership. In this embodiment, inventory 108 may reflect the available vehicles owned by a dealership that potential customer 106 may purchase. In other embodiments, inventory 108 may be an inventory of food, electronics, clothes, or any other consumer product. Inventory 108 may be digital objects, such as media files, streams, or software. In some embodiments, the items in the inventory are not sold at all, rather rented, leased, or otherwise transferred from the seller to the buyer. One skilled in the relevant art(s) will appreciate that the variety of items that may kept in inventory 108 is expansive and far-reaching.

Sales management tool 110 may provide a seller with various tools and services, e.g., sales management capabilities, customer-relationship management tools, inventory management, personnel management, and any other suitable functions. In the context of a dealership, sales management tool 110 may manage an inventory of vehicles, track sales, handle finances, market vehicles, create invoices, and perform a wide-array of other tasks. Sales management tool 110 may include user interface component 111, search interface 112, data store 113, search results generator 114, consumer constraint engine 116, lender policy and pricing engine 118, dealer engine 120, dealer profile 122, policy distance engine 124, and budget distance engine 126.

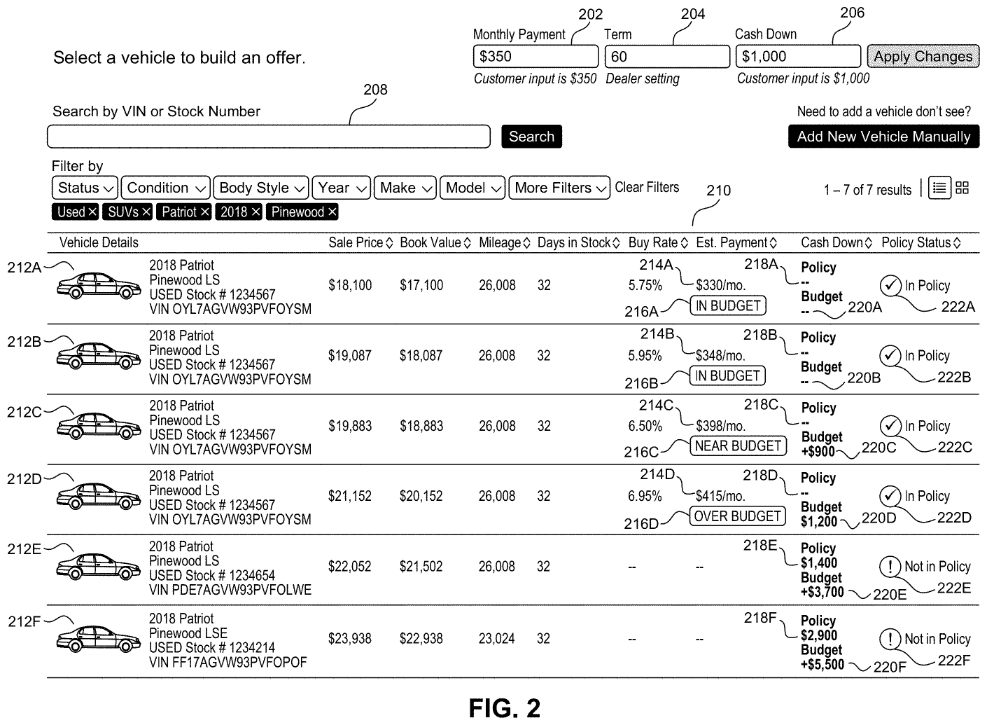

Sales management tool 110 may provide a search page, via which user 102 and/or potential customer 106 may examine a representation of the items in inventory 108 or a subset thereof. Such a search-results page is described in further detail below with reference to FIG. 2. Sales management tool 110 may narrow, limit, and/or filter the results displayed in the search results to those items in the inventory that both satisfy consumer-affordability needs and lender-policy requirements. Sales management tool 110 may allow additional filtering, grouping, sorting, etc. of the search results. Sales management tool 110 may determine affordability indicators, e.g., a policy distance and a budget distance, for each displayed item and include the affordability indicators in the search result.

User interface components 111 may be employed by sales management tool 110 to render a user interface that includes a search page for view by user 102 using computing device 104. User interface components 111 may include a JavaScript user interface library to facilitate dynamic interactions between user 102 and sales management tool 110. User interface components 111 may allow a business or organization to upgrade components used by sales management tool 110 to change the experience for user 102 over time. The screen displays displayed in FIG. 2 are merely exemplary, and the particular look and feel of the search results may change over time. However, user interface components 111 may provide the ability to inform users as to whether a particular item is in-policy and in-budget via an in-policy indicator and an in-budget indicator, described in further detail below as in-policy indicator 222 and in-budget indicator 216. User interface components 111 may also provide the ability to display quantitative indicators of how far out of policy/budget the item is, described below as policy distance 218 and budget distance 220.

Search interface 112 may provide a visual mechanism through which user 102 may examine a representation of items within inventory 108. Search interface 112 may provide user 102 a search result that includes a subset of the total inventory of vehicles available at the dealership, the in-policy and in-budget indicators, the determined policy, sales-price-reduction, and budget distances, along with a wide-array of other details about the items and performable operations thereon. Search interface 112 may provide additional capabilities to user 102 to further limit, refine, sort, group, and otherwise interact with the search results. FIG. 2 below provides one example of search interface 112.

Data store 113 may be a plurality of data storage systems housing information relevant to, used in, and stored by sales management tool 110 and include a representation of inventory 108. Data store 113 may further house pricing information, customer information, sales records, etc. For instance, data store 113 may be a database management system or relational database tool. Data store 113 may further be a message queue or stream processing platform such as Apache Kafka or Apache Spark or other data storage systems like Apache Hadoop, HDFS, or Amazon S3, to name just some examples. Data store 113 may be a data lake, data silo, semi-structured data system (CSV, logs, xml, etc.), unstructured data system, binary data repository, or other suitable repository. Data store 113 may store thousands, millions, billions, or trillions (or more) of objects, rows, transactions, records, files, logs, etc. while allowing for the creation, modification, retrieval, archival, and management of this data. In an embodiment, data store 113 uses scalable, distributed computing to efficiently catalog, sort, manipulate, and access stored data.

Search results generator 114 may be employed by sales management tool 110 to generate search results and return the results to user 102 via search interface 112. To generate appropriate search results, search results generator 114 may employ consumer constraint engine 116, lender policy and pricing engine 118, and dealer engine 120. By employing these components, search results generator 114 may narrow, limit, and/or filter the results displayed in the search results to those representations of items in inventory 108 that both satisfy consumer-affordability needs and lender-policy requirements. As described in further detail below, search results generator 114 may further employ policy distance engine 124 to determine a policy distance, budget distance engine 126 to determine a budget difference, and sales price reduction distance engine to determine a sales-price reduction distance.

Consumer constraint engine 116 may derive, store, and provide a variety of consumer constraints and financial considerations about a multitude of past, current, and potential customers. Example consumer constraints include income, credit score or rating, cash available for a down payment, and a variety of other individualized/personalized financial indicators. In one embodiment, consumer constraint engine 116 may ascertain particularized consumer constraints for potential customer 106 by employing a pre-approval intake process. Such an embodiment may gather financial information from potential customer 106 and facilitate the generation of pre-approval documents from a lender. This acquiring of consumer constraints may also be accomplished through an intake process that automatically ascertains financial information while pre-qualifying the potential customer with a qualified lender. In another embodiment, consumer constraint engine 116 may import information about potential customer 106 from ancillary systems. In another embodiment, user 102 may manually enter consumer constraint information into sales management tool 110.

Lender policy and pricing engine 118 may generate and catalog permutations of financial structures acceptable by one or more qualified lenders for items in inventory 108. A lender policy may address factors such as an amount of down payment, an APR or interest rate, a monthly payment, a term length, as well as consumer constraints and various other financing conditions. Lender policy and pricing engine 118 may harness or leverage an appropriate constraint programming toolkit or library that provides software for combinatorial optimization to catalog the numerous permutations of structures in a reasonable amount of time. Lender policy and pricing engine 118 may place additional limitations on the financial structures to include in the permutations based on a calculated threshold of likely acceptability, i.e., how likely it is to be acceptable to the lender and the seller. Lender policy and pricing engine 118 may omit from the permutations financial structures falling below a certain threshold of likely acceptability.

In one embodiment, lender policy and pricing engine 118 may calculate structures for a single lender and determine if the structures meet that single lender's policies. However, in another embodiment, lender policy and pricing engine 118 may catalog structures and perform calculations against those structures by integrating policy-information from multiple lenders. In such an embodiment, lender policy and pricing engine 118 may integrate and store policy information unique to the multiple lenders and display such information in the search results.

Lender policy and pricing engine 118 may also generate and organize financial structures that consider information about potential customer 106. In some embodiments, every single available financing option for at least one lender across all of the vehicles at a dealership may be cataloged. In this example, the vehicles catalogued may be refined or expanded using pre-filtering, e.g., based on vehicle preferences such as make, model, year, type, etc. Lender policy and pricing engine 118 may determine structures may describe financial arrangements for the financing of the purchase of a vehicle such as: price, rebate value, cash down, taxes, licensing/plating fees, trade-in values, APR or interest rate, term lengths, amount of back-end product (GAP, Warranty), and a variety of other variables. Such structures may be grouped according to equity requirements, e.g., to increase a down payment and/or to decrease a sales price, to allocate financing into a front-end and/or backend, etc.

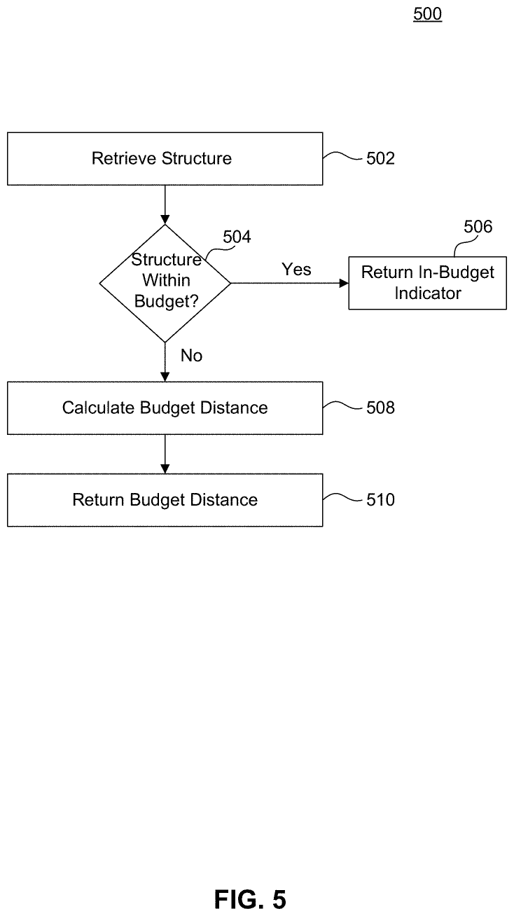

Dealer engine 120 may catalog, track, and maintain a litany of information about a dealer. Dealer engine 120 may compile information about a dealer (or other appropriate seller) as a dealer interacts with sales management tool 110 or ancillary systems. Dealer engine 120 may provide the information to search interface 112 to limit the search results to a subset of the inventory that matches dealer preferences and characteristics. Dealer engine may build a dealer profile, such as dealer profile 122, as described in further detail below with reference to FIG. 5. Dealer engine 120 may provide information about the dealer to lender policy and pricing engine 118 to allow lender policy and pricing engine 118 to vary the possible permutations based on characteristics and preferences of the dealer. For example, a dealership may have demonstrated a willingness to adjust prices downward when completing sale. For such a dealership, the lender policy and pricing engine 118 may consider the list price as a dynamic variable in determining the permutations to consider.

Dealer profile 122 may store information about the behavior of a dealership over time to improve search results by tailoring the search results to the dealerships unique characteristics. For example, dealer profile 122 may include a dealer class associated with a dealership. For example, a dealer class may be “no haggle,” for a dealership that does not negotiate certain contractual terms with potential customer 106. Such a dealer class may be used by dealer engine 120 in tandem with search results generator 114 to provide structures to a dealer that the dealer is more likely to accept, e.g., terms that do not include a negotiated rebate or other charges. For another example, a class may be assigned to a dealership of “profit maximizing,” which would offer structures to a dealership that increase the profits from the sale. In some embodiments, dealer profile 122 may store only one class per dealership, with the dealership placed in a suitable bucket. In other embodiments, a dealership may be placed in multiple buckets, i.e., assigned more than one class. Thus, as a dealership interacts with sales management tool 110 over time, a class may be assigned to a dealership based on that dealership's behavior, and search results generator 114 may provide search results more suited to a dealership's unique characteristics. In some embodiments, dealer engine 120 may allow a dealership to manually configure dealer profile 122. In this fashion, a dealership may tailor the financial structures provided by lender policy and pricing engine 118 and the search results provided by search results generator 114 to match changing goals. For example, sales goals might change at a particular time of year for a particular dealership towards a focus on moving inventory. For this period, a dealership may manually configure their dealer profile 122 towards an increased likelihood of acceptance across all the financial structures.

In an embodiment, with the customer-specific financial information provided by consumer constraint engine 116, the set of financial structures from lender policy and pricing engine 118, and the inventory of vehicles, search results generator 114 may provide a search result that sorts by, highlights, prioritizes, etc., vehicles that simultaneously meet consumer-affordability, lender-policy requirements, and user-preferences. Given the set of consumer constraints, every single possible permutation of financial structures may be considered for every vehicle within the vehicle inventory. These permutations may be grouped according to entity requirements, e.g., all cash down increase, all sales price reduction, or some combination thereof at gradients. The permutations may be further limited by considering user vehicle preferences within lender policy and pricing engine 118. For example, lender policy and pricing engine 118 may refine and pre-filter the permutations of financial structures based on make, model, year, type, etc. as provided by potential customer 106. With only those vehicles and structures displayed that satisfy the consumer constraints, a sales representative is guaranteed to select a vehicle for which financing options are available with at least one lender. This avoids the problem of demoing a vehicle that cannot ultimately be financed to potential customer 106.

Policy distance engine 124 may determine a distance needed for a structure to apply to a vehicle that satisfies consumer constraints, dealership preferences, and available lender-approved financing structures. In one embodiment, policy distance engine 124 may calculate a dollar amount needed to be added to the down payment for a nearest structure to apply. In another embodiment, policy distance engine 124 may calculate a dollar amount that the sales price needs to be reduced. In another embodiment, both of these types of policy distances may be calculated and displayed. One skilled in the relevant art(s) will understand that these two approaches require separate calculations because as the sales price is reduced the loan-to-value ratio changes, thus further impacting a potential financial structure. In other embodiments, policy distance engine 124 may calculate a policy distance in accordance with other variables, e.g., a change to term, warranty, guaranteed-asset-protection insurance modifications, other backend and front end products, trade value, participation, rebates, incentives, etc.

Budget distance engine 126 may determine a distance needed to bring a financial structure into compliance with a potential customer's budget. Budget distance engine 126 may calculate a dollar amount needed to be added to the down payment to bring the item and associated structure into conformance with specified budget information. Budget distance engine 126 may also calculate a dollar amount that the sales price needs to be reduced to bring the item and associated structure into conformance with specified budget information. In another embodiment, both of these types of budget distances may be calculated and displayed. In other embodiments, budget distance engine 126 may calculate a budget distance in accordance with other variables, e.g., a change to term, warranty, guaranteed-asset-protection insurance modifications, other backend and front end products, trade value, participation, rebates, incentives, etc.

FIG. 2 is an example screen display of a search result in a sales management tool, according to some embodiments. The screen display provided in FIG. 2 is merely exemplary, and one skilled in the relevant art(s) will appreciate that many approaches may be taken to provide a suitable screen display 200 in accordance with this disclosure. Screen display 200 provides a mechanism through which user 102 may view a subset of represented items in inventory 108, e.g., vehicles, and sort, filter, and otherwise interact with the subset. Screen display 200 provides interface fields via which budget information may be received about potential customer 106. Screen display 200 may include target monthly payment 202, term 204, cash down 206, search field 208, results 210, items 212, and monthly payment 214. Screen display 200 may further include affordability indicators, e.g., indicators as to the applicability of policies and whether the policy is in budget, i.e., in-budget indicator 216 and in-policy indicator 222. Screen display 200 may also include calculated distances, i.e., policy distance 218 and budget distance 220.

Target monthly payment 202 may be entered by user 102 to reflect a desired amount of monthly payments for potential customer 106. Various methods may be employed by sales management tool 110 to receive budget information about potential customer 106. Target monthly payment 202 provides one suitable approach where the amount is a dollar value desired to be paid monthly towards purchasing the item. This budget information may be used subsequently by budget distance engine 126 to determine whether a selected financial structure is in-budget and, if out-of-budget, a distance to bring the structure within the budget. Target monthly payment 202 in FIG. 2 is displayed as being entered as dollars-per-month, however, other suitable approaches may be used, e.g., in an amount-per-year, in different currencies, using a slider or other input mechanism, etc.

Term 204 may be entered by user 102 to limit the structures considered by lender policy and pricing engine 118 to a particular term length. In FIG. 2, user 102 has entered 60 months, i.e., a 5-year term, in term 204. The result of this exemplary input is that subsequent calculations will only consider financial structures having a 60-month term. Other suitable input mechanisms and approaches may be employed to receive a value representing term 204. For example, user 102 may be able to specify a term range. In one embodiment, when term 204 is left blank by user 102, then all structures may be examined, regardless of their term.

Cash down 206 may be entered by user 102 to indicate an amount of a down payment offered by potential customer 106. Cash down 206 may be specified in an appropriate currency using any suitable input mechanism. In other embodiments, cash down 206 may specify a range of cash down values. Other fields may be included in addition to cash down 206, term 204, and target monthly payment 202 within the scope of this disclosure, e.g., a desired APR rate or range, variance ranges, overpayment amounts, etc.

Search field 208 provides user 102 with the ability to further refine the search results by adding additional search criteria. For example, user 102 may enter a particular VIN or Stock Number of an item in inventory 108 to limit the results. Or user 102 may enter a year, make, model, price range, days in stock, mileage, or any other suitable characteristics about a vehicle or financing structure to further refine the search results.

Results 210 may display a list of items in inventory 108 that satisfy entered search criteria. Results 210 may include a variety of information about each displayed item. One skilled in the relevant art(s) will understand that the exact fields displaying in results 210 may vary based on the type of items being displayed and/or according to configurations and other considerations. In one embodiment, results 210 may default to displaying all items in inventory 108, with the ability to divide the results across pages to improve performance and readability. Moreover, results 210 may be sorted by default in a variety of ways, e.g., by year, model, price, etc. In one embodiment, results 210 may be sorted by the determined policy distance, i.e., vehicles with a positive in-policy indicator may display first, followed by the remaining vehicles sorted in descending order by the distance to being in policy. Thus, the vehicles quantitatively closest to being in policy may display first. In some embodiments, the sorting and filtering of results 210 may be controlled by user 102 through appropriate sorting/grouping mechanisms.

Items 212, such as item 212B, item 212C, and item 212D, may represent the goods in inventory 108. Items 212 may reflect a determined subset of items in inventory 108. In the exemplary embodiment illustrated in screen display 200, a variety of other information is displayed to distinguish items 212, e.g., the VIN, make, year, model number, cost, book value, days in stock, book, differential, payment per month, and APR. In this fashion, user 102 may view only those items that potential customer 106 may ultimately receive financing for from a qualified lender. This associated information may differ based on the nature of items 212 and other factors.

Monthly payment 214 may display in the search results when lender policy and pricing engine 116 determines a matching structure for a particular item in inventory 108. Monthly payment 214 may reflect an amount of money that potential customer 106 pays each month towards the approved financing agreement upon completion of the sales transaction. In some embodiments, lender policy and pricing engine 118 may calculate monthly payment 214 by subtracting the amount of cash down from the price of the item, then dividing this difference by the term of the loan, while considering the monthly interest rate. As indicated in FIG. 2, when no structure is found matching the desired item, e.g., a displayed with respect to item 212E and item 212F, screen display 200 may not display monthly payment 214 or may display monthly payment 214 as zero because no matching structure was found by lender policy and pricing engine 118.

In-budget indicator 216 may provide user 102 a visual indication of whether the determined structure further complies with the provided budget information, e.g., target monthly payment 202. In various embodiments, in-budget indicator 216 may display as “In Budget,” “Near Budget,” or “Over Budget,” as “On Target,” “Near Target,” or “Over Target,” as “In Payment,” “Near Payment,” or “Over Payment,” or in other suitable language/symbols. Appropriate colors or other visual cues may be included to easily convey this information to user 102, e.g., the words “In Budget” may display with a green background, the words “Near Budget” may display with a yellow background, and the words “Over Budget” may display with a red background. An item may be considered “Near Budget” when the item and policy do not satisfy the budget information, but do fall within a threshold amount of satisfying the budget information. For example, an item may display as “Near Budget” if the monthly payment under the determined structure falls within 50 dollars of target monthly payment 202. As indicated in FIG. 2, when no structure is found matching the desired item, e.g., item 212E and item 212F, in-budget indicator 216 may be omitted from the display. The calculation of in-budget indicator 216 is described in further detail below with reference to FIG. 5.

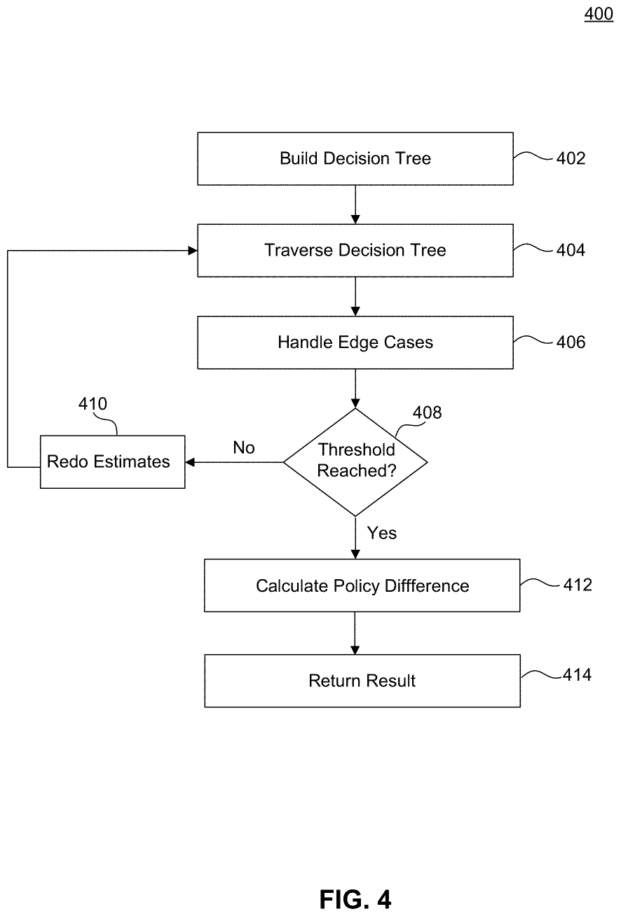

Policy distance 218 may reflect the determined distance for an item to be covered by a financial structure that satisfies the consumer constraints, a lender policy, and the item. Such an example is displayed in FIG. 2 with respect to item 212E and item 212F. In the exemplary illustration in FIG. 2, item 212A, item 212B, item 212C, and item 212D have a null value displaying in policy distance 218 because these items have a matched structure, i.e., the search result displays an in-policy indicator of “In Policy.” In one embodiment, policy distance 218 may be displayed as a dollar (or other currency) amount required to be added to the down payment to bring the item into coverage. In another embodiment, policy distance 218 may display as a dollar amount required in the form of a sales-price reduction. In another embodiment, both of these types of policy distances may be calculated and displayed. An efficient approach to calculating policy distance 218 across all items in inventory 108 is described in further detail below with reference to FIG. 4.

Budget distance 220 may reflect an amount needed to bring the item and determined financial structure into accordance with budget information specific to potential customer 106, e.g., target monthly payment 202. In one embodiment, budget distance 220 represents an amount needed to be additionally applied to the down payment to bring the item into budget. In other embodiment, budget distance 220 can be a sales price reduction or other approach to bring a determined financial structure into conformance with the specified budget information. Budget distance 220 thus operates independently from policy distance 218 to provide important information to user 102 for use in the sales process. As portrayed in FIG. 2, where a positive in-budget indicator is displayed, e.g., in association with item 212A, no budget distance 220A is displayed because budget distance engine 126 determined that the item and associated payment terms complied with the budget information. For example, the monthly payment specified by the applicable policy was less than target monthly payment 202. An efficient approach to calculating budget distance 220 is described in further detail below with reference to FIG. 5.

In-policy indicator 222 may provide an indication of whether a financing structure was found for an item. In an embodiment, in-policy indicator 222 may display as a positive indicator when a policy is found, e.g., a green check mark, the words “In Policy”, or other suitable visual cue readily conveying the information to user 102 that lender policy and pricing engine 118 found a structure satisfying the item, the consumer constraints, and a lender policy. Similarly, when no structure is found, a negative indicator may display, e.g., a red exclamation point, the words “Not in Policy”, or other suitable visual cue. In some embodiments, in-policy indicator may display a “Near Policy” indicator when no structure is found, but the item has a calculated policy distance falling within a certain threshold. For example, an item may display as “Near Policy” if less than 50 additional dollars added to the down payment would result in a matching financial structure.

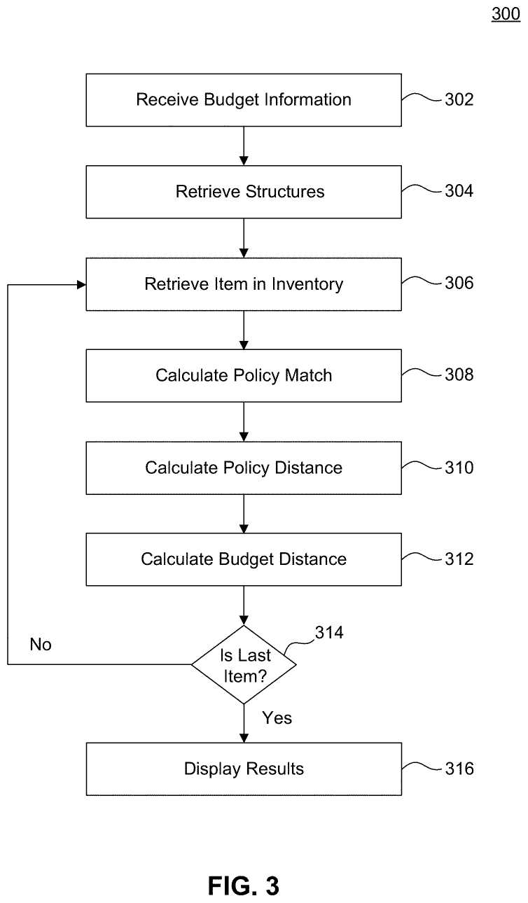

FIG. 3 is a flowchart illustrating a method of displaying a search result that displays affordability indicators in a sales management tool, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, sales management tool 110 may receive budget information from and/or about potential customer 106. In one embodiment, user 102 may enter an appropriate value in target monthly payment 202. The value may represent an amount of desired monthly payment for potential customer 106 in dollars or other currency. The budget information may take other forms and/or include additional details about the budget available to potential customer 106, e.g., a percentage of salary. In another embodiment, sales management tool 110 may calculate an appropriate target monthly payment 202 for display in the interface based upon financial factors about potential customer 106 known to sales management tool 110, e.g., by considering the monthly income and expenses of potential customer 106. In another embodiment, sales management tool 110 may receive budget information about potential customer 106 through an interaction with an external service.

In 304, sales management tool 110 may retrieve a multitude of structures catalogued by lender policy and pricing engine 118. Sales management tool 110 may narrow these structures according to parameters inputted in search field 208. The structures may include factors such as price of the item, an amount of down payment, an APR or interest rate, a monthly payment, a term length, as well as consumer constraints and various other financing conditions. The structures may comprise millions or billions or more of permutations. Accordingly, sales management tool 110 may retrieve these structures and store them in an appropriate data structure capable of manipulating the vast number of records. As described in further detail below with reference to FIG. 4, in one embodiment, polices may be organized into a decision tree for use in determining whether a financial structure exists that satisfies the item, lender-policies, and customer constraints.

In 306, sales management tool 110 may retrieve an item in inventory 108. Sales management tool 110 may limit the selection of items in inventory 108 according to parameters inputted in search field 208. For example, if the search is limited to “blue” vehicles, then sales management tool 110 may retrieve an appropriate blue vehicle in inventory 108. In one embodiment, sales management tool 110 may examine all items in inventory 108 by default, thus performing subsequent calculations for all items in inventory 108. Sales management tool 110 may examine the items in a particular order or randomly.

In 308, sales management tool 110 may employ lender policy and pricing engine 118 to determine if the item retrieved in 306 is satisfied by a structure among the structures retrieved in 304. As discussed above, lender policy and pricing engine 118 may consider the price of the item, consumer constrains, the loan-to-value ratio, etc.. In one embodiment, lender policy and pricing engine 118 may build a decision tree of all available structures and iteratively traverse that decision tree to heuristically determine a matching structure. The algorithm may further handle various edge cases and employ thresholds to ensure the timeliness of results. This approach is described in further detail below with reference to FIG. 4. In some embodiments, when determining the policy match across inventory 108, lender pricing and policy engine 118 may employ additional techniques to optimize the performance of these calculations. For example, lender pricing and policy engine 118 may use parallelization techniques across the entirety of inventory 108 or a subset relevant to the search.

In 310, sales management tool 110 may employ policy distance engine 124 to determine a policy distance. The policy distance quantitatively indicates how close a particular item is to having a matching financial structure. In one approach, this distance can be expressed as a dollar amount required to be added to the down payment, e.g., as specified in cash down 206. In another approach, this distance can be expressed as a dollar amount that the sales price of the item needs to be reduced. In one embodiment, policy distance engine 124 may employ both approaches and calculate both values. If an appropriate financing structure is found in 308, then policy distance engine 124 may set the policy distance to zero or null, as a structure covering the customer constraints, lender policy, and item characteristics has been found. However, if no structure is found, then policy distance engine 124 may calculate the policy distance by building a decision tree based on the various policies retrieved in 304 and then iteratively traversing the decision tree using estimated cash down increments until the nearest structure is found, a threshold is reached, or an edge case is attained. Further detail about this technique is provided below with reference to FIG. 4.

In 312, sales management tool 110 may employ budget distance engine 126 to calculate a budget distance based on the item retrieved in 306, the structure determined in 308, and the budget information retrieved in 302. The budget distance may quantitatively represent an amount needed to bring an item/structure into compliance with a potential customer's budget. In one approach, the budget distance may be expressed as a dollar amount required to be added to the down payment, e.g., as specified in cash down 206, to bring the item into compliance with the budget information. In another approach, the budget distance may be expressed as a dollar amount that the sales price of the item needs to be reduced by to bring the item into compliance with budget information. In one embodiment, budget distance engine 126 may employ both approaches and calculate both values. Policy distance engine 124 may engage lender policy and pricing engine 118 to determine if the item retrieved in 306 is satisfied by a policy among the policies retrieved in 304. Further detail about the calculation of the budget distance is provided below with reference to FIG. 5.

In 314, sales management tool 110 may determine if the item retrieved in 306 is the last item to be retrieved in inventory 108 and displayed in the search result. If not, then method 300 may return to 306 to retrieve the next item. If yes, then method 300 may proceed to 316. In some embodiments, steps 306 through 314 may be performed in parallel to optimize performance.

In 316, sales management tool 110 may display the search results for user 102. The search result may include policy distance 218 and budget distance 220. The search result may include in-budget indicator 216 and in-policy indicator 222. Sales management tool 110 may employ many suitable design approaches to relay the search results. One such example is described above with reference to exemplary screen display 200. The search results screen may facilitate further refinement of the search results through additional sorting, grouping, and filtering. In one approach, the results may be sorted by policy distance 218, i.e., items with matching structures may display at the top of the search result and the items without matching structures may appear in order of proximity, i.e. by policy distance. For example, user 102 may enter a detail applicable to items in inventory 108, and the items will be further limited to display only that detail. In other embodiments, sales management tool 110 may display search results in a table, spreadsheet, graph or other visualization, document, text file, or other suitable medium.

FIG. 4 illustrates a method 400 of calculating a policy distance for display in a search result in a sales management tool, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, sales management tool 110 may build a decision tree of the available structures catalogued by lender policy and pricing engine 118, or a subset thereof relevant to a particular inquiry. In one embodiment, the structures may be specified as a series of criteria or rules, and the structures may be specified using a comma-separated value (CSV) file, XML file, JSON file, or other suitable manner of organization. The rules may further specify periods of applicability, e.g., a date range or other temporal aspect. The decision tree may be built such that each node of the tree-structure includes appropriate rules allowing the traversal of the tree using the customer constraints and details about the item.

In 404, sales management tool 110 may traverse the decision tree built in 402 by applying consumer constraints and other details, e.g., price about the particular item being examined. Sales management tool 110 may also consider term 204 and cash down 206 when traversing the decision tree. In other embodiments, sales management tool 110 may consider additional variables such as term, warranty, guaranteed-asset-protection insurance modifications, other backend and front end products, trade value, participation, rebates, incentives, etc. Policy distance engine 124 may examine the rules at each branch of the tree. When the traversal ends up in a leaf node that specifies a valid structure in the first iteration, then policy distance engine 124 and/or lender policy and pricing engine 118 may determine that the structure found in the leaf node satisfies the cost of the item, the policy, and the one or more constraints. This structure found through the traversal may be preserved for use in subsequent steps. However, when no leaf node is found matching the item and customer constraints, then policy distance engine 124 and/or lender policy and pricing engine 118 may determine a nearest structure and calculate a policy distance after redoing the estimates in step 410. In such an instance, lender policy and pricing engine 118 may perform the above steps using the revised estimates. When the revised estimates result in a traversal of the decision tree finding a leaf node that satisfies the cost of the item, the policy, and the one or more constraints, the associated structure may be stored and referred to as the nearest structure.

In 406, sales management tool 110 may handle various edge cases. These edge cases provide safeguards that act when situations arise that would otherwise cause the decision-tree traversals to occur infinitely and/or to prevent inappropriate real-world scenarios from occurring. Such edge cases require additional logic. For example, if an extremely low financing amount is sought, e.g., 50 dollars, no financial structure may exist at all to cover the amount. This is known as the “minimum amount to finance” floor. Similar edge cases may be required with respect to the sales price reduction values. In these instances, policy distance engine 124 may short circuit the evaluation to avoid unnecessary calculations and may return an appropriate error message or perform other suitable action.

In 408, sales management tool 110 may determine if a threshold has been reached. That is, once the iterative tree traversals reach a certain threshold, the heuristic method disclosed ceases and appropriate results may be returned to the search. For example, policy distance engine 124 may employ a 50-cent threshold, and once the estimated cash down increments or sales price decrements drops shrinks below 0.5, the iterations will stop and the affordability indicators calculated and returned for the item. If a threshold has not been reached, then method 400 may return to 410 to continue iteratively traversing the decision tree. If a threshold has been reached, then method 400 may proceed to 412 to return the search result to user 102.

In 410, sales management tool 110 may estimate updated constraints to re-apply to the decision tree to determine if a more optimal financial structure can be found, i.e., a structure with a smaller policy distance. Sales management tool 110 may estimate a different amount of cash down and/or a different sales price reduction. These estimates may be referred to as estimated cash down increments/decrements when revising the amount of cash down. The estimates may be referred to as estimated sales price reduction increments/decrements when examining the sales price reductions. In one embodiment, sales management tool 110 may double the amount of cash down when a policy has not been matched in the prior traversal, and sales management tool 110 may halve the amount of cash down when a policy was found in the prior traversal of the decision tree. Other appropriate scaling factors may be used based on the size of inventory 108 and other factors.

In 412, sales management tool 110 may return a result including policy distance 218 and in-policy indicator 222 to search results generator 114. In-policy indicator 222 may be positive when a policy is found in the tree traversal during the first iteration. In-policy indicator 222 may be negative when additional cash-down increments and/or sales-price reductions are determined. In one embodiment, policy distance 218 may be the optimal estimated cash down increment that results in a financial structure being found that satisfies the item, the lender policies, and the customer constraints when traversing the decision tree in 404. In another embodiment, policy distance 218 may be the optimal estimated sales-price reduction decrement that results in a structure being found by traversing the decision tree in 404. In another embodiment, both calculations may be performed and returned to determine the policy distance.

In 414, sales management tool 110 may return a result including policy distance 218 and in-policy indicator 222 to search results generator 114. Sales management tool 110 may then employ a suitable design approach to displaying the affordability indicators, e.g., as displayed in FIG. 2.

FIG. 5 is a flowchart illustrating a method of calculating a budget distance for an item displayed in a search result in a sales management tool, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, budget decision engine 126 may receive an item and financial structure. In one embodiment, the matching structure may already have been determined (e.g., as described above with reference to FIGS. 3 and 4) and budget distance engine 126 may receive the appropriate information for use in subsequent calculations. In another embodiment, budget distance engine 126 may re-engage lender policy and pricing engine 118 to determine the applicable structure, nearest structure, policy and budget distances, etc.

In 504, budget decision engine 126 may determine if the item being examined satisfies the budget information received from potential customer 106. If the item is within budget, then method 500 may proceed to 506. However, if the item does not satisfy the budget information, then method 500 may proceed to 508.

In 506, budget decision engine 126 may return a positive in-budget indicator, e.g., in-budget indicator 216. A positive in-budget indicator alerts user 102 that the item complies with the entered budget information, e.g., target monthly payment 202, under the terms of the matched policy. Budget decision engine 126 may return the positive indicator to search results generator 114 for incorporation into the search results being calculated across inventory 108 or a subset thereof and displayed to user 102.

In 508, sales management tool 110 may calculate a budget distance, i.e., budget distance 220 for the item and policy received in 502. Budget distance 220 may be represented as a sales price reduction amount, an increased cash down amount, both of the foregoing, or another suitable quantitative indicator. In another embodiment, budget distance 220 may be represented by the difference between target monthly payment 202 and the monthly payment specified in the received policy. In such an embodiment, budget distance 220 may be represented as a dollar amount that the item is out of budget on a per monthly basis. In other embodiments, the budget distance may be a change to term, warranty, guaranteed-asset-protection insurance modifications, other backend and front end products, trade value, participation, rebates, incentives, etc.

In 510, sales management tool 110 may return the budget distance to search results generator 114 to display in the search results.

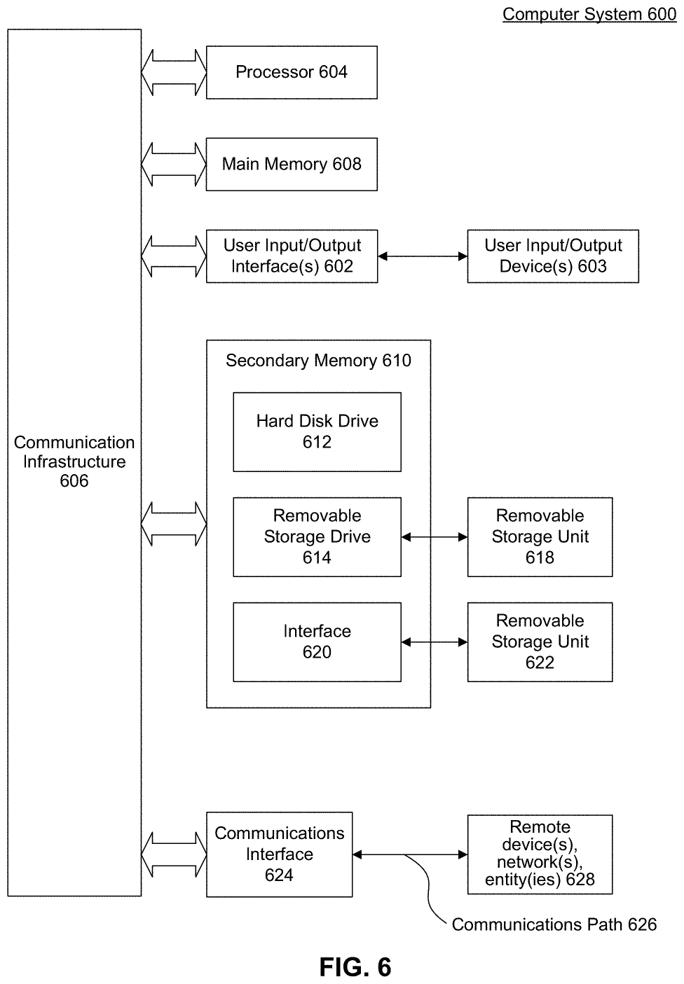

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 608, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A computer implemented method, comprising:
storing, in a management tool, an inventory of items and one or more rules of a policy of a lender for determining lender approved financing options for a structure;
for each item in the inventory of items,
generating, by one or more processors, a plurality of structures based on the policy;
determining, by the one or more processors, a nearest structure in the plurality of structures and calculating a policy difference representing a change needed for the nearest structure to satisfy the cost of the item, an in-policy approval of the lender, and the one or more constraints; and
providing, by the one or more processors, a search result in the management tool comprising the inventory of items, an in-policy indicator for each item, and the policy difference.

2. The method of claim 1, the determining a nearest structure further comprising:
generating, by the one or more processors, a decision tree based on the plurality of structures; and
traversing, by the one or more processors, the decision tree based on the one or more constraints and characteristics of the item to determine the nearest structure.

3. The method of claim 2, the calculating a policy difference further comprising:
iteratively traversing, by the one or more processors, the decision tree using estimated cash down increments and revising the estimated cash down increments in each iteration based on a result of the traversal until the nearest structure satisfies the cost of the item, the policy, and the one or more constraints or a threshold is reached.

4. The method of claim 1, wherein the change needed is a sales price reduction.

5. The method of claim 4, further comprising:
displaying, by the one or more processors, in the search result, the sale price reduction value for each item in the inventory of items.

6. The method of claim 1, further comprising:
receiving, by the one or more processors, budget information for the customer;
calculating, by the one or more processors, a budget difference representing a second change needed for the nearest structure to satisfy the budget information in addition to satisfying the cost of the item, the policy, and the one or more constraints; and
displaying, by the one or more processors, in the search result, an in-budget indicator and the budget difference for each item in the inventory of items.

7. The method of claim 6, wherein the budget information comprises a desired monthly payment.

8. The method of claim 6, wherein the second change needed is a second sales price reduction, further comprising:
displaying, by the one or more processors, in the search result, the second sales price reduction value for each item in the inventory of items.

9. The method of claim 1, wherein the change needed can be a change to term, warranty, guaranteed-asset-protection insurance modifications, other backend and front end products, trade value, participation, rebates, and/or incentives.

10. The method of claim 1, further comprising:
receiving, by the one or more processors, a term and an available amount of cash down; and
limiting, by the one or more processors, the inventory of items in the search result based on the term.

11. The method of claim 1, wherein the one or more constraints comprise a credit score and a monthly income.

12. The method of claim 1, wherein the item is associated with a sales price, a book value, a mileage, and a number of days in stock.

13. The method of claim 1, wherein the management tool is a vehicle management tool and the inventory of items is an inventory of vehicles at a dealership.

14. The method of claim 1, wherein the lender approved financing options comprise a rate, a term, and a price.

15. A system, comprising:
a memory storing an inventory of items in a management tool and one or more rules of a policy of a lender for determining lender approved financing options for a structure; and
at least one processor coupled to the memory and configured to:
for each item in the inventory of items,
generate a plurality of structures based on the policy;
determine a nearest structure in the plurality of structures and calculate a policy difference representing a change needed for the nearest structure to satisfy the cost of the item, an in-policy approval of the lender, and the one or more constraints; and
provide a search result in the management tool comprising the inventory of items, an in-policy indicator for each item, and the policy difference.

16. The system of claim 15, the at least one processor further configured to:
receive budget information for the customer;
calculate a budget difference representing a second change needed to satisfy the budget information in addition to satisfying the cost of the item, the policy, and the one or more constraints; and
display in the search result, an in-budget indicator and the budget difference for each item in the inventory of items.

17. The system of claim 16, wherein the second change needed is a second sales price reduction, the at least one processor further configured to:
display, in the search result, the second sale price reduction value for each item in the inventory of items.

18. The system of claim 16, wherein to determine a nearest structure, the at least one processor is further configured to:
generate a decision tree based on the plurality of structures; and
traverse the decision tree based on the one or more constraints and characteristics of the item to determine the nearest structure.

19. The system of claim 18, wherein to determine the nearest policy the at least one processor is further configured to:
iteratively traverse the decision tree using estimated cash down increments and revise the estimated cash down increments in each iteration based on a result of the traversal until the nearest structure satisfies the cost of the item, the policy, and the one or more constraints or a threshold is reached.

20. A non-transitory computer-readable device having instructions stored thereon that, when executed by at least one computing device, cause the at least one computing device to perform operations comprising:
storing an inventory of items in a management tool and one or more rules of a policy of a lender for determining lender approved financing options for a structure;
for each item in the inventory of items,
generating a plurality of structures based on the policy;
determining a nearest structure in the plurality of structures and calculating a policy difference representing a change needed for the nearest structure to satisfy the cost of the item, an in-policy approval of the lender, and the one or more constraints; and
providing a search result in the management tool comprising the inventory of items, an in-policy indicator for each item, and the policy difference.
